(19) United States
(12) Patent Application Publication
(10) Pub. No.: US 2014/0013821 A1
(43) Pub. Date: Jan. 16, 2014

(54) Method of Evaluating Friction Stir Welding Defects

(71) Applicants: Murray Mahoney, Dayton, TX (US); Russell Steel, Dayton, TX (US); Jeremy Peterson, Dayton, TX (US); Raymond Rowland, Dayton, TX (US); Rodney Bond, Dayton, TX (US)

(72) Inventors: Murray Mahoney, Dayton, TX (US); Russell Steel, Dayton, TX (US); Jeremy Peterson, Dayton, TX (US); Raymond Rowland, Dayton, TX (US); Rodney Bond, Dayton, TX (US)

(21) Appl. No.: 13/764,337

(22) Filed: Feb. 11, 2013

Related U.S. Application Data
(63) Continuation of application No. 13/537,581, filed on Jun. 29, 2012, now abandoned.
Application No. 13/537,581 is a continuation of application No. 13/295,363, filed on Nov. 14, 2011, now abandoned.
Application No. 13/295,363 is a continuation of application No. 13/076,855, filed on Mar. 31, 2011, now abandoned.
Application No. 13/076,855 is a continuation of application No. 12/857,877, filed on Aug. 17, 2010, now abandoned.
(60) Provisional application No. 61/234,430, filed on Aug. 17, 2009.

(51) Int. Cl. G01N 19/02

(52) U.S. Cl. CPC G01N 19/02
USPC 73/9

(57) ABSTRACT

A method of evaluating defects in a friction stir welded seam is provided, the method including: providing a welded sheet of metallic stock, the sheet having a top edge and a bottom edge, opposed side edges, and a joining seam formed between the opposed side edges by means of friction stir welding; isolating a preselected test specimen from the sheet of welded metallic stock, the specimen comprising either the top edge or the bottom edge and a test portion of the seam, with the test portion extending from an intermediate point to either the top or bottom edge and having a longitudinal axis, so that said test portion is disposed perpendicularly to the longitudinal axis, thereby establishing a test specimen face and a weld root; and detaching the specimen from the sheet and then testing the integrity of said weld root.

### FIELD OF THE INVENTION

The present invention relates generally to methods of evaluating friction stir welding defects, and in particular, to a method of evaluating defects in joined strip stock caused by friction stir welding processes that might otherwise go undetected using either other detection methods or no defect detection methods at all.

### BACKGROUND

Friction stir welding (“FSW”) is a solid-state process by which metals or other materials are joined without the use of fusion or filler materials. FSW has been used in the past to join light-weight metals. In the past, only aluminum and other highly malleable, light-weight metals have been welded in this manner.

Welds created by FSW result from the combination of frictional heating and mechanical deformation, and do not require application of external weldment materials such as welding wire. A detailed description of the FSW process may be found in U.S. Pat. No. 5,460,317.

FSW is most often used when the application requires the characteristics of the resulting material to remain as unaltered as possible. In typical FSW applications, two pieces of material are butted together and rigidly clamped to prevent the joint faces from being forced apart. To ensure a quality weld, run-on and run-off tabs are used to permit the starting and stopping of a weld beyond the edge of the subject metal.

A cylindrical rotary tool with an attached probe is rotated and traversed across (and to a partial extent through) the desired joint region. Significant frictional heat is generated during this process, thereby causing the opposed pieces of metal to temporarily enter into a plasticized and deformable condition while apparently still retaining a solid state. As the rotating probe is traversed along the joint line, the newly plasticized portion is spread along the joint. When the probe is removed, the plasticized region quickly cools and reforms as a durable solid, thereby joining the two pieces of metal into a single structurally integral whole.

Since there is no melting of an associated weld wire, the heat-affected zone of a friction stir weld is practically eliminated after the process has been completed. Also, since with friction stir welding there is no need for filler wire, there is never any corresponding chemical discontinuity as is associated with the prior art. In short, the hardness variation across a FSW weld is very uniform, thereby eliminating the need to post-heat-treat, as is frequently required with ordinary welding.

To date, however, small edge defects (e.g., minor but noticeable deformations) have frequently been observed after friction stir welding, especially on the advancing side of the tool when welding across a run-on tab, as well as on the retreating side of the tool when traversing a run-off tab, after the tool is rotated across the desired joint region.

These defects are created when the FSW tool traverses the edge of a metal sheet and the flow direction of the tool pulls neighboring material into the structure. Through prior unsuccessful attempts to cure this problem, those of skill in the art have learned that the defect size can be reduced, though not eliminated, through various adjustments in the weld parameters.

Current evaluation methods for evaluating a weld for defects created by the FSW process include optically evaluating the root side of the weld for interface hooking and observing the polished surface at low magnification after carefully removing the run-on and run-off tabs. Under the current method, the absence of hooking on the root side and the lack of a defect upon visual inspection of a semi-polished, transverse cross-section of the weld interface would be deemed sufficient to qualify the weld as “defect-free.”

However, while in many applications of FSW minor defects are of little or no consequence, in many other applications (for example, those relevant to the oil and gas industry) it is extremely important that there are virtually no defects in the finished joined strip stock, as high temperatures, high pressures, and other severe fluid and mechanical stresses will eventually result in a localized damaging effect that can ultimately destroy the integrity of the joined strip stock, thereby endangering costly, time consuming operations and materials, and possibly even human lives.

There is, therefore, a long-felt but unmet need for an evaluation method useful for evaluating the defects created in metal stock joined through FSW processes, especially when the joined metal stock will subsequently be used in an application where it is vital that the resultant joined stock contain virtually no structural defects.

### SUMMARY OF THE INVENTION

A method of evaluating defects in a friction stir welded seam is provided, the method including: providing a welded sheet of metallic stock, the sheet having a top edge and a bottom edge, opposed side edges, and a joining seam formed between the opposed side edges by means of friction stir welding; isolating a preselected test specimen from the sheet of welded metallic stock, the specimen comprising either the top edge or the bottom edge and a test portion of the seam, with the test portion extending from an intermediate point to either the top or bottom edge and having a longitudinal axis, so that said test portion is disposed perpendicularly to the longitudinal axis, thereby establishing a test specimen face and a weld root; and detaching the specimen from the sheet and then testing the integrity of said weld root. An additional step of comparing the results of the weld root testing to a predetermined set of testing criteria, as well as specific testing techniques are also provided in order to confirm the integrity of the weld.

### BRIEF DESCRIPTION OF DRAWINGS

FIG. 1 is a schematic representation of metal flow into and away from the edge of the metallic stock as a FSW tool traverses through a run-on tab and onto the edge of a metal strip while the FSW tool is rotating in a counterclockwise manner.

FIG. 2 is a schematic view comprising an isolated specimen of metallic stock, depicted such that the specimen contains an edge of the friction stir weld seam, and the weld seam is disposed perpendicularly relative to the longitudinal axis of the specimen.

FIG. 3 is an illustration of the removal of the isolated specimen from the metallic stock.

FIG. 4 is a top view of the isolated specimen after removal from the parent stock.

FIG. 5 is a schematic representation of a cross-section of a specimen after its removal.

FIG. 6 is an illustration of a side view of the specimen following completion of a root bend test.

FIG. 7 is an illustration of a side view of the specimen after completion of a face bend test.

### DETAILED DESCRIPTION

The present invention overcomes the deficiencies in the prior art by providing an improved method of evaluating FSW defects that would have otherwise gone undetected, especially for applications in which a basically flawless end product is required to satisfy related technical specifications.

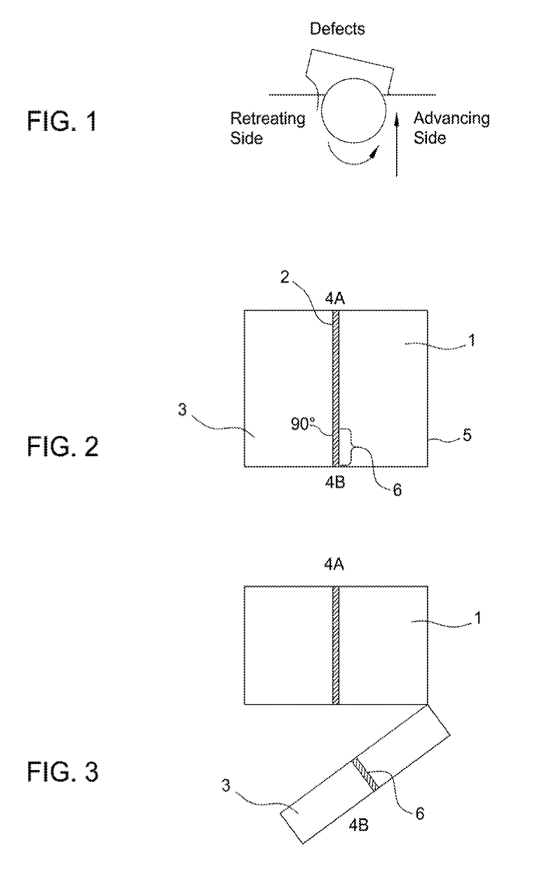

As seen in FIG. 1, metal flows into and away from the edge of the metallic stock when an FSW tool traverses through the tab and onto the edge of the metal stock. In one specific though non-limiting embodiment, a full-penetration friction stir weld across a complete width of a sheet of 0.019 inch thick HSLA-90 steel utilizes run-on and run-off tabs, and a FSW tool traverses the metal sheet at a rate of around 300 rpm and 3 inches/minute. After the weld is completed, the run-on and run-off tabs are removed. These specific materials and dimensions are provided for illustrative purposes only, and are not limitative of the method claimed below.

FIG. 2 depicts how the specimen is isolated from surrounding material. In the depicted embodiment, the sheet of metallic stock 1 comprises a seam portion 2, formed between opposed side portions of metallic stock by means of friction stir welding.

A preselected test specimen 3 is then isolated, so that it comprises an upper (or lower) edge portion 4A or 4B, as well as an isolated weld portion 6.

In the depicted embodiment, isolated weld portion 6 is a sub-portion of friction stir welded seam 2, selected such that the isolated weld portion 6 is disposed approximately perpendicularly relative to a longitudinal axis 5 of the isolated specimen 3. In other embodiments, the welding process can be tested using a full sheet of welded stock, though the isolation method disclosed above achieves maximum efficacy for the process as shown and described herein.

In a further embodiment, FIG. 3 depicts the removal of the isolated specimen 3 from the sheet 1 so that the efficacy of the weld can be evaluated. It is also possible to assess the integrity of the weld while an isolated portion remains attached to the sheet, but artisans of sufficient skill will readily recognize that the process is rendered simpler and more reliable if the isolated test specimen 3 is first detached from the sheet 2.

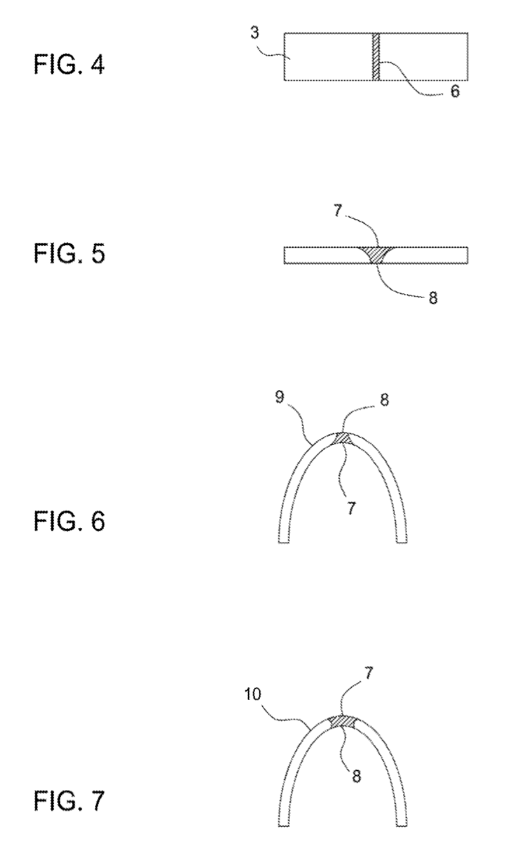

The example embodiment of FIG. 4 illustrates a top view of the test specimen 3 after removal of the test specimen from the metallic stock.

The example embodiment of FIG. 5 illustrates a cross-sectional view of the specimen following removal of the specimen from the metallic stock, in this instance comprising a face side 7 of the seam 2 and a root side 8 of the seam 2.

The example embodiment of FIG. 6 shows a cross-section of the isolated specimen 3 following a bending test, so that the root side 8 is in tension, thereby forming an associated convex root surface 9.

In a still further embodiment, FIG. 7 shows a cross-section of the isolated specimen 3 following a bending test, so that the face side 7 is in tension and a convex face surface 10 is formed.

Detailed analysis of the weld portion of the isolated specimen can be undertaken at any time, or at several predetermined or randomly selected intervals during the course of the test. Optimally, repeatable evidence of a consistent weld having defects only so minor as to reside entirely within a range of predetermined defect characteristics will be achieved.

For example, having friction stir welded opposing side portions of metallic stock together, weld characteristics can be assessed by either direct measurement means (e.g., calipers or other precision tool means, etc.) or microscopically.

Appropriate testing methods for evaluating the integrity of the welded region of an isolated test specimen also comprise detailed analysis of resultant molecular structures, gas chromatography, mass spectrometry, emission spectroscopy, etc., as well as any other repeatable examination technique likely to yield an affirmative definition of the precise molecular structure of the joined materials.

Tests drawn to accurate measurement of specimen thickness, hardness, and malleability are also desirable. Ultimately, the goal of the process is to ensure that an entire weld portion of a test specimen demonstrably resides within the parameters of a plurality of associated test requirements. Depending upon the end-use of the product, different criteria may be selected from a menu of possible test parameter options.

For example, in one example embodiment a test specimen is measured for thickness and hardness after initial separation from an associated sheet of metallic stock that has been joined using FSW. The specimen is then examined using mass spectrometry in order to confirm the molecular composition of the specimen. In another embodiment, gas chromatography is then used to determine whether any gas was trapped within the weld seam during the period when the subject stock was in a plastically deformed state, and is still present in sufficiently appreciable amounts that might compromise the integrity of the weld. The specimen is then flexed such that a convex root weld portion is formed, and then restored to its original unflexed position; the specimen is then evaluated for structural integrity. A reverse step in which the weld root is rendered concave is then formed and then the specimen restored to its original position; again, the results are critically evaluated. Finally, the specimen is carefully re-measured to determine whether the thickness of the weld is approximately identical to the initial value found prior to flexing of the weld portion, or whether portions of the weld were defective, thereby resulting in a thin section of the specimen after mechanical manipulation.

Other tests combining stressing and flexing of an isolated weld portion and subsequent evaluation using highly precise measurement and/or structural analytics will also occur to skilled artisans in order to confirm the integrity of the weld.

The foregoing specification is provided for illustrative purposes only, and is not intended to describe all possible aspects of the present invention. Moreover, while the invention has been shown and described in detail with respect to several exemplary embodiments, those of ordinary skill in the art will appreciate that minor changes to the description, and various other modifications, omissions, and additions may also be made without departing from the spirit or scope thereof.

1. A method of evaluating defects in a friction stir welded seam, said method comprising:
a. providing a welded sheet of metallic stock, said sheet having a top edge and a bottom edge, opposed side edges, and a joining seam formed between said opposed side edges by means of friction stir welding;
b. isolating a preselected specimen from said sheet of welded metallic stock, said specimen comprising either said top edge or said bottom edge, and a test portion of said seam, said test portion extending from an intermediate point to either said top edge or said bottom edge and having a longitudinal axis, so that said test portion is disposed perpendicularly to said longitudinal axis, thereby establishing a test specimen face and a weld root; and
c. detaching said test specimen from said sheet and testing the integrity of said weld root.

2. The method of claim 1, further comprising: comparing the results of said weld root testing to a predetermined set of testing criteria in order to confirm the integrity of the weld.

3. The method of claim 1, wherein said testing further comprises: bending said test specimen such that said face or said root is in tension and forms a convex outer surface.

4. The method of claim 3, wherein said bending occurs substantially within only said face or said root.

5. The method of claim 3, further, comprising: evaluating said convex outer surface both during and after said bending in order to detect defects in said face or said root.

6. The method of claim 3, wherein said bending of the test specimen further comprises bending caused by a guided bend test jig.

7. The method of claim 1, wherein said testing further comprises: bending said test specimen such that said face or said root is in tension and forms a concave outer surface.

8. The method of claim 7, wherein said bending occurs substantially within only said face or said root.

9. The method of claim 7, further, comprising: evaluating said concave outer surface both during and after said bending in order to detect defects in said face or said root.

10. The method of claim 3, wherein said bending of the test specimen further comprises bending caused by a guided bend test jig.
